(19) United States
(12) Patent Application Publication
(10) Pub. No.: US 2026/0062593 A1
(43) Pub. Date: Mar. 5, 2026

(54) ALKALI-DISPERSIBLE TYPE HOT MELT PRESSURE-SENSITIVE ADHESIVE

(71) Applicant: Henkel AG & Co. KGaA, Düsseldorf (DE)

(72) Inventor: Ai Takamori, Osaka (JP)

(21) Appl. No.: 19/384,069

(22) Filed: Nov. 10, 2025

Related U.S. Application Data
(63) Continuation of application No. PCT/JP2024/019201, filed on May 24, 2024.

(30) Foreign Application Priority Data
May 25, 2023 (JP) 2023-086123

(51) Int. Cl. C09J 7/35; C09J 11/06; C09J 11/08

(52) U.S. Cl. CPC C09J 7/35; C09J 11/06; C09J 11/08; C09J 2203/334; C09J 2301/304; C09J 2301/408

(57) ABSTRACT

There is provided an alkali dispersible-type hot melt pressure-sensitive adhesive, comprising:
(A) a thermoplastic block copolymer that is a copolymer of vinyl aromatic hydrocarbons and conjugated diene compounds,
(B) a metallocene olefin polymer,
(C) a tackifying resin, and
(D) at least one selected from the group consisting of fatty acids and derivatives thereof.

### TECHNICAL FIELD

The present invention relates to an alkali-dispersible type hot melt pressure-sensitive adhesive (PSA) that is suitable as a PSA for labels of glass bottles, PET (polyethylene terephthalate) bottles, and the like, and in particular relates to an alkali-dispersible type hot melt PSA that is effective as a PSA used for bonding a PET bottle for carbonated beverages and a label.

### BACKGROUND ART

Generally, aluminum cans, glass bottles, and polyethylene terephthalate (PET) bottles are widely distributed as containers for medicines, foods, and drinks. Labels are applied to these containers by the PSA with such strength that they cannot be removed by hand. As labels for beverage containers, body-wrapping labels (roll labels) made of polyethylene terephthalate (PET) film, biaxially oriented polypropylene film (OPP), and polylactic acid (PLA) film are often used.

When reusing containers with labels applied, it is necessary to collect the used containers in a factory, immerse the containers in a heated aqueous alkaline solution, and separate the labels from the containers. Therefore, the PSA applied to labels for containers is required to have properties (alkali dispersibility) that allow the labels to peel off from the containers in a short time by swelling, softening, dispersing, or being solubilized in the aqueous alkaline solution.

Patent Documents 1 to 4 disclose an alkali-dispersible type hot melt PSA containing a styrene-based block copolymer, a tackifying resin, and oil and fat. Hot melt PSAs in these documents contain modified rosin as a tackifying resin, and contain coconut oil, rice oil, sunflower oil, rapeseed oil and the like as oils and fats.

The alkali-dispersible type hot melt PSA is required to excel not only in “alkali dispersibility” but also in adhesiveness (holding strength) between a label and a container. Particularly in the beverage field, in addition to “alkali dispersibility” and “holding strength”, it is also required not to leave any adhesive on the container after peeling off the label from the container, that is, to have excellent re-peelability.

In beverage manufacturers, during the production of carbonated beverages, there is a process of filling PET bottles having had labels applied to them with carbonated beverages. If a PET bottle is left to stand after being filled with carbonated beverage, carbon dioxide may slightly expand the PET bottle, and cause the problem that the label is lifted and peeled off from the bottle. However, hot melt PSAs described in Patent Documents 1 and 2 were insufficient to resolve the problem of label lifting and peeling. In the beverage industry, an alkali-dispersible type hot melt PSA with particularly excellent holding strength is desired.

Furthermore, the alkali-dispersible type hot melt PSA is required to reduce stringiness during coating. When applying a hot melt PSA, a dedicated coating apparatus such as a hot melt applicator or a labeler is often utilized. The hot melt PSA is heated to about 120 to 190° C. and applied to a label, which serves as an adherend, from a head of the dedicated coating apparatus. When the hot melt PSA is applied to the label, stringlike material of the hot melt PSA may be generated between the tip of the head and the label. Further, the stringlike material may be generated between the applied label and an as-yet unapplied label. This stringlike material is attributable to stringing properties of the hot melt PSA, and stains the head or label. Therefore, developing a hot melt PSA with less stringiness is a crucial responsibility for adhesive manufacturers.

### PRIOR ART DOCUMENTS

### Patent Documents

Patent Document 1: JP 2014-159563 A
Patent Document 2: JP 2016-204588 A
Patent Document 3: JP 2021-095443 A
Patent Document 4: JP 2021-095448 A

### SUMMARY OF INVENTION

### Problem to be Solved by the Invention

Demands for improved performance of hot melt PSAs have become stricter in recent years. Under such circumstances, hot melt PSAs of Patent Documents 1 and 2 are still insufficient in the improvement of stringing properties. Hot melt PSAs of Patent Documents 3 and 4 have improved stringing properties, and meet the industry demands in this respect.

However, it has become evident that a body-wrapping label (biaxially oriented polypropylene film (OPP) and the like) peels off due to vibrations and the like during transportation. Consequently, there arises a demand to increase the adhesive strength at film overlapping portions of the body-wrapping label of the bottle.

The present invention was made to solve the above problems, and intends to provide an alkali-dispersible type hot melt PSA that has high alkali dispersibility, excellent label-holding strength, is less likely to cause the problem of adhesive residue, capable of reducing stringiness, and furthermore has excellent adhesive strength between body-wrapping labels.

The present invention and preferred embodiments of the present invention are as follows.
1. An alkali dispersible-type hot melt PSA, comprising:
(A) a thermoplastic block copolymer that is a copolymer of vinyl aromatic hydrocarbons and conjugated diene compounds,
(B) a metallocene olefin polymer,
(C) a tackifying resin, and
(D) at least one selected from the group consisting of fatty acids and derivatives thereof.
2. The alkali dispersible-type hot melt PSA of embodiment 1, comprising 1 to 20 parts by weight of the metallocene olefin polymer (B), based on 100 parts by weight of the total weight of components (A) to (D).
3. The alkali-dispersible type hot melt PSA of embodiment 1 or 2, wherein the metallocene olefin polymer (B) has a weight-average molecular weight of 12,000 or more.
4. The alkali-dispersible hot melt PSA of any one of embodiments 1 to 3, wherein the metallocene olefin polymer (B) comprises a copolymer of ethylene and an olefin having 3 to 20 carbon atoms.
5. The alkali dispersible-type hot melt PSA of any one of embodiments 1 to 4, wherein the thermoplastic block copolymer (A) comprises (A1) a styrene block copolymer having a styrene content of less than 40% by mass.
6. The alkali-dispersible type hot melt PSA of embodiment 5, comprising 70 parts by mass or more of the styrene block copolymer (A1) having a styrene content of less than 40% by mass, based on 100 parts by weight of the total weight of the components (A) to (D).
7. The alkali-dispersible type hot melt PSA of any one of embodiments 1 to 6, wherein the tackifying resin (C) includes a rosin ester and an alpha-methylstyrene-based resin.
8. The alkali-dispersible type hot melt PSA of any one of embodiments 1 to 7, further comprising Fischer-Tropsch wax.
9. A label having a PSA layer consisting of the alkali-dispersible type hot melt PSA of any one of embodiments 1 to 8.
10. A body-wrapping label having a PSA layer consisting of the alkali-dispersible type hot melt PSA layer of any one of embodiments 1 to 8 at overlapping portions of both film ends to be bonded to each other when wrapped around a body portion of a container.
11. The label of embodiment 9 or 10, having a substrate consisting of a polypropylene film.
12. A container to which the label of any one of embodiments 9 to 11 is applied.

The alkali-dispersible type hot melt PSA of the present invention may be used to bond a label to containers such as a PET bottle and a glass bottle, and has excellent label-holding strength. For example, when a label is applied to a container, such as a PET bottle filled with carbonated beverage, with the alkali-dispersible type hot melt PSA of the present invention, the label displacement and lifting are less likely to occur even when the container expands.

The alkali-dispersible type hot melt PSA of the present invention has high alkali dispersibility, and when the container is immersed in an aqueous alkaline solution with the label applied, there is no adhesive residue, and the label can be cleanly peeled off. Furthermore, the alkali-dispersible type hot melt PSA of the present invention allows the label to be re-peeled off by hand force or other means, and leaves less adhesive residue when the label is re-peeled off.

The alkali-dispersible type hot melt PSA of the present invention is suitable for use in containers and the like to be recycled and processed due to its superior performance described above.

The alkali-dispersible type hot melt PSA of the present invention is applied to labels and the like using a dedicated coating apparatus or the like, and it is possible to suppress the occurrence of stringiness when applied.

In addition, the hot melt PSA of the present invention has excellent adhesive strength, particularly shear strength, between body-wrapping labels. Even when a label is applied to a container and the container with the label is transported for an extended period, film overlapping portions of the body-wrapping label won't be peeled off from the container due to vibrations and the like during transportation.

### DESCRIPTION OF EMBODIMENTS

The alkali-dispersible type hot melt PSA of the present invention comprises all four components: (A) a thermoplastic block copolymer that is a copolymer of vinyl aromatic hydrocarbons and conjugated diene compounds, (B) a metallocene olefin polymer, (C) a tackifying resin, and (D) at least one selected from the group consisting of fatty acids and derivatives thereof.

In the present description, they are also referred respectively to as “component (A)”, “component (B)”, “component (C)”, and “component (D)”, and the alkali-dispersible type hot melt PSA of the present invention is sometimes also simply referred to as “hot melt PSA”.

### <(A) Thermoplastic Block Copolymer>

A thermoplastic block copolymer (A) is a copolymer in which vinyl aromatic hydrocarbons and conjugated diene compounds are block-copolymerized, and is usually a resin composition having a vinyl aromatic hydrocarbon block and a conjugated diene compound block.

Here, the “vinyl aromatic hydrocarbon” means an aromatic hydrocarbon compound having vinyl groups. Specifically, for example, styrene, o-methylstyrene, p-methylstyrene, p-tert-butylstyrene, 1,3-dimethylstyrene, alpha-methylstyrene, vinylnaphthalene, vinylanthracene and the like may be exemplified. Styrene is particularly preferred. These vinyl aromatic hydrocarbons may be used alone or in combination.

The “conjugated diene compound” means a diolefin compound having at least one pair of conjugated double bonds. As the “conjugated diene compound”, specifically, for example, 1,3-butadiene, 2-methyl-1,3-butadiene (or isoprene), 2,3-dimethyl-1,3-butadiene, 1,3-pentadiene, and 1,3-hexadiene may be exemplified. 1,3-butadiene and 2-methyl-1,3-butadiene are particularly preferred. These conjugated diene compounds may be used alone or in combination.

The thermoplastic block copolymer (A) used in the present invention may be either unhydrogenated or hydrogenated.

Specific examples of “unhydrogenated products” of the thermoplastic block copolymer may include those in which blocks based on the conjugated diene compound are not hydrogenated. Also, specific examples of “hydrogenated products of the thermoplastic block copolymer (A)” may specifically include block copolymers in which all or part of the blocks based on the conjugated diene compound are hydrogenated.

The percentage of “hydrogenated products” of the thermoplastic block copolymer (A) may be indicated by a “hydrogenation ratio”. The “hydrogenation ratio” of the “hydrogenated thermoplastic block copolymer (A)” refers to a percentage of double bonds that have been hydrogenated and converted to saturated hydrocarbon bonds, based on the total aliphatic double bonds in the blocks based on the conjugated diene compound. This “hydrogenation ratio” may be measured by an infrared spectrophotometer and a nuclear magnetic resonance apparatus.

As an aspect of the present invention, it is preferable that the thermoplastic block copolymer (A) is a styrene-based block copolymer. The styrene-based block copolymer means a polymer having at least one styrene block. The styrene block means a segment in which styrene is the principal monomer, and it is preferable that the segment is substantially only of styrene.

Specific examples of the unhydrogenated products of the thermoplastic block copolymer (A) may include, for example, a styrene-isoprene-styrene block copolymer (also referred to as SIS) and a styrene-butadiene-styrene block copolymer (also referred to as SBS). Specific examples of the hydrogenated products of the thermoplastic block copolymer (A) include, for example, a hydrogenated styrene-isoprene-styrene block copolymer (also referred to as SEPS), a hydrogenated styrene-butadiene-styrene block copolymer (also referred to as SEBS), and a hydrogenated styrene-butylene-butadiene block copolymer (also referred to as SBBS).

In the present invention, the weight-average molecular weight (Mw) of the compound included as component (A) is not particularly limited, but is preferably 1.0×104 to 3.0×105, more preferably 5.0×104 to 2.0×105.

In the present description, the weight-average molecular weight is determined by gel permeation chromatography (GPC) using a calibration curve using monodisperse molecular weight polystyrene as a standard substance to convert the molecular weight.

The alkali-dispersible type hot melt PSA of the present invention has excellent cohesive force by including the thermoplastic block copolymer (A). This results in an excellent balance between label-holding strength and adhesive residue, and enhances the shear strength at adhesive portions between body-wrapping labels.

In one aspect of the present invention, the thermoplastic block copolymer (A) (the component (A) is sometimes also referred to as (A1)) preferably comprises a styrene block copolymer having a styrene content of less than 40% by mass (the “component (A1)”). The “styrene content” refers to the proportion of styrene included in the thermoplastic block copolymer. The styrene content of the component (A1) is preferably less than 40% by mass, more preferably less than 35% by mass, and still more preferably 15% by mass or more and less than 35% by mass.

When the hot melt PSA of the present invention comprises the component (A1) having a styrene content within the above range, the label may be held stably on a container such as a PET bottle, and the label is less likely to be lifted or displaced.

In the hot melt PSA of the present invention, the content of the component (A1) is preferably 70 parts by mass or more, more preferably 80 parts by mass or more, and may even be 100 parts by mass, based on 100 parts by mass of the total amount of the component (A). The hot melt PSA of the present invention has better holding strength when the content of the component (A1) is within the above range.

The thermoplastic block copolymer (A) may be used alone or in combination of two or more. As one embodiment, (A1) a styrene-based block copolymer having a styrene content of less than 40% by mass and a styrene-based block copolymer that does not fall under the component (A1) may be blended. The styrene-based block copolymer that does not fall under the component (A1) mean those having a styrene content of 40% by mass or more (hereinafter sometimes referred to as “(A2) a styrene-based block copolymer having a styrene content of 40% by mass or more” or “component (A2)”).

In the present invention, commercially available products may be used as the styrene block copolymer (A1) having a styrene content of less than 40% by mass. Examples thereof may include:
Tufprene T420 (trade name), Tuftec P3000 (trade name), and TUFTEC H1053 (trade name) manufactured by Asahi Kasei Chemicals Corp.;
Quintac 3460 (trade name), Quintac 3433N (trade name), Quintac 3520 (trade name), and Quintac 3270 (trade name) manufactured by Zeon Corporation;
D1160 (trade name), Kraton G1650 (trade name), Kraton G1652 (trade name), and Kraton G1657 (trade name) manufactured by Kraton Corporation.

The component (A) is preferably a triblock-type styrene-based block copolymer having a diblock content of 0% by mass. Particularly, when the triblock styrene-based block copolymer having a diblock content of 0% by mass is used as the component (A1), the holding strength of the hot melt PSA becomes more excellent.

In the present description, the “diblock” means a block copolymer having two blocks, and usually means a block copolymer having one “vinyl aromatic hydrocarbon block”, preferably one “styrene block” and one “conjugated diene compound block (which may be hydrogenated)”, and it may be represented, for example, by the following formula (1).

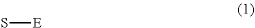

(In Formula (1), S is a styrene block, and E is a conjugated diene compound block.)

In the present description, the “diblock content” of the component (A) refers to the ratio of diblock copolymers (preferably a block copolymer having one styrene block and one conjugated diene compound block represented by formula (1)) contained in the thermoplastic copolymer of the component (A).

The triblock-type styrene-based block copolymer is, for example, preferably a styrene-based block copolymer having the structure represented by the following formula (2) and containing no other blocks.

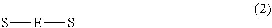

(In formula (2), S is a styrene block and E is a conjugated diene compound block.)

In the present description, the triblock-type styrene-based block copolymer has a diblock content of 0% by mass, and is distinguished from the diblock-type styrene-based block copolymer.

In the present invention, it is most desirable that the component (A1) is a styrene-ethylene/butylene-styrene (SEBS) triblock copolymer. The hot melt PSA of the present invention significantly has an improved cohesive force by including a styrene-ethylene/butylene-styrene (SEBS) triblock copolymer. This enables label adhesion to be held over a long period when the label is bonded to the container with the hot melt PSA without lifting of the label from the container and also without displacement of the label.

Examples of commercially available products of the styrene block copolymer (A2) having a styrene content of 40% by mass or more include:
Asaprene T439 (trade name), Tufprene 125 (trade name), Tufprene A (trade name), Tuftec P2000 (trade name), Tuftec H1043 (trade name), and Tuftec H1051 (trade name) manufactured by Asahi Kasei Chemicals Corp.;
TR2000 (trade name) and TR2250 (trade name) manufactured by JSR Corporation;
SOIT6414 (trade name) manufactured by EniChem Co. Each of these commercial products may be used alone or in combination.

### <(B) Metallocene Olefin Polymer>

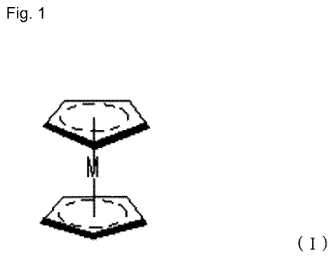

(B) A “metallocene olefin polymer” refers to a polymer in which olefins are polymerized in the presence of a metallocene catalyst. The metallocene olefin polymer includes a chemical structure derived from the metallocene catalyst in its molecule. As an example of the chemical structure derived from the metallocene catalyst, the metallocene catalyst itself, as shown in Formula (I) in FIG. 1, or a chemical structure that also includes a modified form of Formula (I) may be exemplified.

### Explanation of FIG. 1: Chemical Formula (I)

In Formula (I), M represents a metal or a metal bonded with a halogen atom.

The viscosity of the metallocene olefin polymer (B) at 170° C. is 10,000 mPa s or less, more preferably 1000 to 10,000 mPa s, and still more preferably 2000 to 8000 mPa s. The viscosity of the metallocene olefin polymer (B) at 170° C. is measured with a Brookfield RVT viscometer (spindle No. 27).

If the alkali-dispersible type hot melt PSA of the present invention contains the metallocene olefin polymer (B), the label is not lifted and also the label is not displaced from the container over an extended period when the label is bonded to the container with this hot melt PSA. In addition, in the body-wrapping label applied to the container with the hot melt PSA of the present invention, even when the container with the label is transported for an extended period, film overlapping portions of the body-wrapping label won't be peeled off from the container due to vibrations and the like during transportation.

Polymerization of olefins using a metallocene catalyst results in the synthesis of (B) metallocene olefin polymers that (i) have crystallinity and (ii) have a very narrow molecular weight distribution. (i) means that the complete isotacticity and syndiotacticity may be optionally controlled. Therefore, polymers that cause no bias in crystallinity, and are uniform in the arrangement and proportion of methyl groups may be obtained, reducing the likelihood of low crystallinity sites that may cause reduced adhesion. For (ii), the degree of molecular weight distribution of the metallocene olefin polymer (B), when expressed as polydispersity (Mw/Mn), is preferably 1.0 to 3.5. Hot melt adhesives containing polyolefins with polydispersities of 1.0 to 3.5 result in excellent adhesive strength. The molecular weight distribution is a concept that indicates the distribution of molecular weight of synthetic polymers, where the ratio of the weight-average molecular weight (Mw) to number-average molecular weight (Mn) (polydispersity: Mw/Mn) serves as a measure. In the present invention, the measurement of the molecular weight distribution is performed by gel permeation chromatography (GPC).

The metallocene olefin polymer (B) may be a homopolymer or a copolymer. Homopolymers include polyethylene, polypropylene and the like.

In this description, the copolymer refers to a copolymer of ethylene and a copolymerizable monomer that may copolymerize with ethylene. Examples of copolymerizable monomers may include α-olefins such as propylene, 1-octene, and 1-butene; carboxylic acids (esters) having ethylenic double bonds such as vinyl acetate, (meth)acrylic acid, (meth)acrylic acid esters, maleic acid, and maleic acid esters; carboxylic anhydrides having ethylenic double bonds such as maleic anhydride and phthalic anhydride. These copolymerizable monomers may be copolymerized with ethylene alone or two or more copolymerizable monomers may be copolymerized.

In other words, in the present invention, examples of the metallocene olefin polymer (B) include homopolymers such as ethylene and propylene, ethylene copolymers such as ethylene/alpha-olefin copolymers, ethylene/carboxylic acid copolymers having ethylenic double bonds, ethylene/carboxylic acid ester copolymers having ethylenic double bonds, and ethylene/carboxylic acid anhydride copolymers having ethylenic double bonds. In the present description, acrylic acid and methacrylic acid are collectively referred to as “(meth)acrylic acid” and acrylic acid esters and methacrylic acid esters are collectively referred to as “(meth)acrylic acid esters. Ethylene/alpha-olefin copolymers include, for example, ethylene/propylene copolymer, ethylene/1-octene copolymer, ethylene/1-butene copolymer, and ethylene/propylene/1-butene copolymer.

From the viewpoint of improving the stringing properties and holding strength, the metallocene olefin polymer (B) is preferably a copolymer of ethylene and an olefin having 3 to 20 carbon atoms, further preferably a polymer based on polyethylene or polypropylene and the like, particularly preferably an ethylene/propylene copolymer, an ethylene/octene copolymer, and most desirably an ethylene/propylene copolymer.

The hot melt adhesive of the present invention particularly has excellent coating properties and exhibits less stringiness if the metallocene olefin polymer (B) is an ethylene/propylene copolymer. If a label is applied to a container with the hot melt PSA of the present invention, and the container with the label is transported for an extended period, film overlapping portions of the body-wrapping label won't be peeled off from the container due to vibrations and the like during transportation.

In the present invention, the weight-average molecular weight of the metallocene olefin polymer (B) is preferably 12,000 or more, particularly preferably 15,000 or more, still more desirably 20,000 to 500,000, and most desirably 25,000 to 400,000. Having the weight-average molecular weight of the component (B) in the above range contributes to the film-overlapping portions of the label being less likely to be peeled off from the container even if the container with the label is transported for an extended period, while maintaining a balance between adhesive residue and holding strength.

The weight-average molecular weight (Mw) means the value measured by gel permeation chromatography (GPC). Specifically, values may be measured using the following devices and measurement method. RI manufactured by Waters Corporation is used as a detector. TSKGEL GMHHR-H(S) HT manufactured by Tohso Corporation is used as a GPC column. A sample is dissolved in 1,2,4-trichlorobenzene and flown at a flow rate of 1.0 mL/min and a measurement temperature of 145° C. The molecular weight is converted using a calibration curve with polypropylene to determine the weight-average molecular weight.

Since the number-average molecular weight (Mn) is also determined by the same method, the molecular weight distribution is also calculated by GPC.

Commercially available products of the metallocene olefin polymer (B) include:
metallocene ethylene/propylene copolymers, such as Vistamax 8780 (trade name), and Vistamax 8880 (trade name) manufactured by Exxon Mobil Corporation;
metallocene ethylene/octene copolymers, such as Affinity GA1900 (trade name), Affinity GA1950, Affinity GA 1875 (trade name), Affinity GA1000R (trade name), Affinity EG8185 (trade name), Affinity EG8200 (trade name), Engage 8137 (trade name), Engage 8180 (trade name), and Engage 8400 (trade name) manufactured by Dow Chemical Company;
metallocene ethylene/octene copolymers, such as Nipolon ZHM510R manufactured by Tohso Corporation, and Excelene FX402 manufactured by SUMITOMO CHEMICAL COMPANY, LIMITED;
metallocene propylene homopolymers, such as L-MODU S400, and L-MODU S600 manufactured by Idemitsu Kosan Co., Ltd.

### <(C) Tackifying Resin>

In the hot melt PSA of the present invention, the holding strength of the label to the container may be improved by including (C) a tackifying resin (component (C)). The “tackifying resin” is not particularly limited as long as it is one normally used in hot melt PSAs, and enables a hot melt PSA targeted by the present invention to be obtained. In the present description, the component (C) shall not include compounds described as components (A) above.

The alkali-dispersible type hot melt PSA of the present invention includes the tackifying resin (C), resulting in excellent compatibility among its components, in an improved balance between label-holding strength and adhesive residue, also in an increase in the shear strength at the adhesive portions between the body-wrapping labels, also in excellent stringiness reducing property, and also in an overall excellent balance.

Examples of tackifying resins may include natural rosins, modified rosins, hydrogenated rosins, glycerol esters of natural rosins, glycerol esters of modified rosins, pentaerythritol esters of natural rosins, pentaerythritol esters of modified rosins, pentaerythritol esters of hydrogenated rosins, copolymers of natural terpenes, three-dimensional polymers of natural terpenes, hydrogenated derivatives of copolymers of hydrogenated terpenes, polyterpene resins, hydrogenated derivatives of phenol-based modified terpene resins, aliphatic petroleum hydrocarbon resins, hydrogenated derivatives of aliphatic petroleum hydrocarbon resins, aromatic petroleum hydrocarbon resins, hydrogenated derivatives of aromatic petroleum hydrocarbon resins, cycloaliphatic petroleum hydrocarbon resins, and hydrogenated derivatives of cycloaliphatic petroleum hydrocarbon resins.

Among these, it preferably contains as the component (C) a tackifying resin having an acid value of 0 to 300 mgKOH/g, more preferably contains a rosin-based tackifying resin having an acid value of 50 to 300 mgKOH/g, still more preferably contains a rosin-based tackifying resin having an acid value of 100 to 300 mgKOH/g, and most preferably contains a rosin-based tackifying resin having an acid value of 100 to 250 mgKOH/g. The acid value within this range more improves the alkali-dispersibility of the hot melt PSA of the present invention.

As one aspect of the present invention, it is preferable that the tackifying resin (C) contains an alpha-methylstyrene-based resin in addition to the rosin-based tackifying resin. The alpha-methylstyrene-based resin enhances the cohesiveness of the hot melt PSA, and improves the re-peelability and holding strength thereof. For example, an alpha-methylstyrene homopolymer or a styrene/alpha-methylstyrene copolymer is used as the α-methylstyrene-based resin.

As one embodiment of the present invention, the α-methylstyrene-based resin as the component (C) is preferably a styrene/alpha-methylstyrene copolymer. As for α-methylstyrene-based resins, those having a softening point (measured by the ring and ball method specified in JIS K2207) of 65 to 160° C. are preferred, and those having a softening point of 85 to 160° C. are more preferred. Specifically, commercially available products such as Kristalex 3085 (trade name), Kristalex 3100 (trade name), Kristalex 1120 (trade name), Kristalex 5140 (trade name), Endix 155 and Plastrin 290 manufactured by Eastman Chemical Company, and FTR-2120 (trade name) manufactured by Mitsui Chemicals, Inc. may be exemplified.

These tackifying resins may be used alone or in combination of two or more. For the tackifying resin, liquid type tackifying resins may also be used as long as they are colorless to pale yellow in color tone, have substantially no odor, and have good thermal stability.

### <(D) Fatty Acid and Derivatives Thereof>

The hot melt PSA of the present invention comprises (D) at least one selected from the group consisting of (D) fatty acids and derivatives thereof (component (D)). When the hot melt PSA comprises the component (D), the hot melt PSA of the present invention has excellent alkali-dispersibility. The component (D) may comprise one kind of compound alone, or may comprise two or more kinds.

In the present description, the fatty acid is an aliphatic carboxylic acid having at least one carboxy group and may have a hydroxy group. Fatty acids are broadly divided into saturated fatty acids and unsaturated fatty acids. Saturated fatty acids are acids that have no double bond or no triple bond in a carbon chain. Unsaturated fatty acids are acids having a double bond or a triple bond in a carbon chain.

Any saturated fatty acid may be used as long as it does not adversely affect the hot melt PSA of the present invention. Those having 1 to 30 carbon atoms are preferred, those having 3 to 26 carbon atoms are more preferred, those having 8 to 24 carbon atoms are more preferred, those having 12 to 22 carbon atoms are still more preferred, those having 14 to 22 carbon atoms are still even more preferred. Saturated fatty acids may be either chainlike or cyclic, and preferably they are chainlike. Chainlike saturated fatty acids may be linear or have a branched chain, and preferably they are linear saturated fatty acids. Specific examples of saturated fatty acids include formic acid, acetic acid, propionic acid, butyric acid, valeric acid, caproic acid, lauric acid, tridecyl acid, myristic acid, palmitic acid, stearic acid, tricosylic acid, 12-hydroxystearic acid and the like.

Any unsaturated fatty acid may be used as long as it does not adversely affect the hot melt PSA of the present invention. Those having 3 to 26 carbon atoms are preferred, those having 4 to 22 carbon atoms are more preferred, and those having 14 to 22 carbon atoms are still more preferred.

The number of unsaturated carbon/carbon bonds in unsaturated fatty acids is preferably 1 to 6, more preferably 1 to 3, and most preferably 1 to 2.

Examples of unsaturated fatty acids include crotonic acid, oleic acid, linolenic acid, docosahexaenoic acid, linoleic acid, and ricinoleic acid.

In the present description, fatty acid derivatives are defined as compounds obtained by substitution or other chemical reactions of the above fatty acids. Examples of fatty acid derivatives include oils and fats, hardened oils, fatty acid amides, fatty acid alkyl esters, monoglycerides, diglycerides, sorbitan fatty acid esters, diglycerol fatty acid esters and the like. Oils and fats, and hardened oils are preferred, and hardened oils are more preferred. “Oils and fats” consist primarily of triglycerides (triacylglycerols), which are esters of fatty acids and glycerols.

The hot melt PSA of the present invention may comprise oils and fats commonly used as edible or industrial oils and fats. Oils and fats may be liquid or solid at room temperature (about 20 to 26° C.), preferably liquid at room temperature, and vegetable oils are preferred. Examples of oils and fats include corn oil, soybean oil, epoxidized soybean oil, sesame oil, linseed oil, olive oil, lettuce oil, fish oil, butter, lard, castor oil, rapeseed oil, sunflower oil, rice oil, and cottonseed oil. One type may be used alone or two or more types may be used in combination.

“Hardened oils” are obtained by hydrogenating oils and fats that are liquid at room temperature and increasing the proportion of saturated fatty acids, which have a higher melting point, to thereby solidify oils and fats at room temperature. Any hardened oil may be used as long as it does not adversely affect the hot melt PSA of the present invention. Specific examples include castor oil subjected to hydrogenation (that is, hydrogenated castor oil), hydrogenated soybean oil, hydrogenated salad oil and the like.

The hot melt PSA of the present invention comprises, as the fatty acid or a derivative thereof (D), (D1) a fatty acid derivative having a melting point of 40° C. or more (also described as “component (D1)” or the “fatty acid derivative (D1)”). The melting point of the fatty acid derivative is preferably 45 to 120° C., more preferably 50 to 100° C., and still more preferably 50 to 90° C. In one aspect of the present invention, it is preferred that the hot melt PSA contains castor oil having a melting point of 50 to 100° C. The component (D1) may comprise one type alone or two or more types.

In the hot melt PSA of the present invention, the melting point of the fatty acid derivative (D1) in the above range improves the holding strength and makes it suitable for labels. When a label is bonded to a PET bottle for carbonated beverages via the hot melt PSA of the present invention, the label is held on the PET bottle for an extended period without any displacement or lifting even when the PET bottle expands with carbon dioxide gas. Furthermore, the alkali-dispersible type hot melt PSA of the present invention exhibits excellent shear strength at the adhesive portions between the body-wrapping labels and also exhibits an improved stringiness reducing property, resulting in an excellent overall balance.

In the present description, the melting point refers to a value measured using differential scanning calorimetry (DSC). Specifically, 10 mg of a sample is weighed in an aluminum container, and measurement is conducted at a temperature increase rate of 5° C./min using DSC 6220 (trade name) manufactured by Nano Technology Inc., and the temperature at the top of the melting peak is referred to as the melting point.

The content of the component (D1), based on 100 parts by mass of the component (D), is preferably 40 parts by mass or more, more preferably 50 parts by mass or more, still more preferably 60 parts by mass or more, and may be 100 parts by mass. In one embodiment of the present invention, in addition to the component (D1), (D2) a fatty acid derivative having a melting point of less than 40° C. (preferably a fat having a melting point of less than 40° C.) may be included.

In the present invention, it is preferable to include a hardened oil as the fatty acid derivative (D1). The melting point of the hardened oil as the component (D1) is 40° C. or more, preferably 50 to 100° C., and more preferably 50 to 90° C. The inclusion of the hardened oil having a melting point of 40° C. or more maintains solidification of the hot melt PSA of the present invention even at high temperatures, and improves cohesive force with the adherend, such as a label, resulting in high holding strength.

Examples of hardened oils include castor oil subjected to hydrogenation (that is, hydrogenated castor oil), hydrogenated soybean oil, hydrogenated salad oil, hydrogenated rapeseed oil, hydrogenated palm oil, hardened beef tallow oil and the like. Particularly, hydrogenated castor oil, hydrogenated soybean oil, and hydrogenated rapeseed oil are preferred, and hydrogenated castor oil is most preferred.

When the hot melt PSA of the present invention comprises hydrogenated castor oil having a melting point of 40° C. or more, it particularly achieves excellent holding strength. In an aspect of the present invention, it is preferred that the hot melt PSA contains hydrogenated castor oil having a melting point of 50 to 100° C. as the component (D1).

In the present invention, commercially available products may be used as the fatty acids or derivatives thereof (D).

Examples of commercially available products of the fatty acid derivatives (D1) include hardened castor oil A (trade name), Technol MH (trade name), Technol ML98 (trade name), 12-hydroxystearic acid (trade name), hydrogenated soybean oil (trade name), hydrogenated rapeseed oil (trade name), hydrogenated palm oil (trade name), and rice wax SS-1 (trade name).

Examples of commercially available products of fatty acid derivatives other than the component (D1) include:
FS Oil (trade name) and Prime Taste (trade name) manufactured by Showa Sangyo Co., Ltd.;
Rice oil (trade name) and rice salad oil (trade name) manufactured by Boso oil and fat Co., Ltd.;
Cottonseed oil (trade name) manufactured by Okamura oil and fat Co., Ltd.;
RIKEMAL (trade name) manufactured by RIKEN VITAMIN CO., LTD.;
NONION (trade name) manufactured by NOF CORPORATION; and the like.

These commercially available fatty acid derivatives may be used alone or in combination.

The hot melt PSA of the present invention may comprise a wax in addition to the components (A) to (D).

The “wax” is an organic substance which is solid at normal temperature and forms liquid when heated, and is not particularly limited as long as the hot melt PSA targeted by the present invention may be obtained. Waxes are generally low polymers (i.e., oligomers). In the present description, waxes are defined as low polymers having a weight-average molecular weight of less than 12,000. Specific examples of waxes include synthetic wax systems such as Fischer-Tropsch wax and polyolefin waxes (polyethylene wax and polypropylene wax); petroleum waxes such as paraffin wax and microcrystalline wax; natural waxes such as castor wax; and the like.

The inclusion of the wax in the hot melt PSA of the present invention reduces the adhesive residue of the hot melt PSA on the container when peeling off the label from the container.

In one aspect of the present invention, the wax preferably includes Fischer-Tropsch wax. Fischer-Tropsch wax is a wax fractionated so that the component molecules have a narrow carbon atoms distribution from a wax having a relatively broad carbon atoms distribution. Fischer-Tropsch wax reduces the adhesive residue of the hot melt PSA more when peeling off the label from the container.

The hot melt PSA of the present invention may include a plasticizer.

The plasticizer is blended for the purpose of reducing the melt viscosity of the hot melt PSA, providing flexibility, and improving wetting to the adherend. The plasticizer is not particularly limited as long as it is compatible with other components, and the hot melt PSA targeted by the present invention may be obtained. Examples of the plasticizer include paraffin-based oils, naphthene-based oils and aromatic oils. Particularly, paraffin-based oils and/or naphthene-based oils are preferred, and colorless and odorless paraffin-based oils are most preferred.

As an example of a commercially available product of the plasticizer, White Oil Broom 350 (trade name) manufactured by Kukdong Oil & Chemicals Co., Ltd., Diana Fresia S-32 (trade name), Diana Process Oil PW-90 (trade name) and Daphne Oil KP-68 (trade name) manufactured by Idemitsu Kosan Co., Ltd., Enerper M1930 (trade name) manufactured by BP Chemicals Limited, Kaydol (trade name) manufactured by Crompton Corporation, Primol 352 (trade name) manufactured by Exxon Corporation, Process Oil NS-100 (trade name) manufactured by Idemitsu Kosan Co., Ltd., and DN4010 manufactured by PetroChina Company Limited may be exemplified. These may be used alone or in combination of two or more.

Blending the plasticizer improves the compatibility of the components (A) to (C) contained in the hot melt PSA of the present invention and further improves the compatibility with other components, and as a result, tackiness, adhesiveness and coating suitability of the hot melt PSA are improved.

The hot melt PSA of the present invention may further contain various additives as required. Examples of such various additives include a stabilizer and a fine particulate filler

The “stabilizer” is blended to prevent the reduction of the molecular weight, gelation, coloration, generation of an odor and the like of the hot melt PSA by heating, and to improve the stability of the hot melt PSA. It is not particularly limited as long as the hot melt PSA targeted by the present invention may be obtained. Examples of the “stabilizer” may include an antioxidant and an ultraviolet absorbing agent.

Examples of the “antioxidant” may include phenol-based antioxidants, sulfur-based antioxidants and phosphorus-based antioxidants. Examples of the “ultraviolet absorbing agent” include benzotriazole-based ultraviolet absorbing agents and benzophenone-based ultraviolet absorbing agents. Furthermore, a lactone-based stabilizer may also be added. These may be used alone or in combination. As commercially available products of antioxidants, the following products may be used.

Specific examples thereof include SUMILIZER GM (trade name), SUMILIZER TPD (trade name) and SUMILIZER TPS (trade name) manufactured by SUMITOMO CHEMICAL COMPANY, LIMITED, Irganox 1010 (trade name), Irganox HP2225FF (trade name), Irgafos 168 (trade name), Irganox 1520 (trade name) and Tinuvin P manufactured by BASF Limited, JF77 (trade name) manufactured by Johoku Chemical Co., Ltd., ADEKASTAB AO-60 (trade name) and ADEKASTAB AO-412S (trade name) manufactured by ADEKA CORPORATION. These stabilizers may be used alone or in combination.

The “ultraviolet absorbing agent” is used to improve the light resistance of the hot melt PSA. The “antioxidant” is used to prevent oxidative degradation of the hot melt PSA.

The hot melt PSA of the present invention may further comprise a fine particulate filler. The fine particulate filler may be a commonly used one, and is not limited as long as the hot melt PSA targeted by the present invention is obtained. Examples of the “fine particulate filler” may include mica, calcium carbonate, kaolin, talc, titanium oxide, diatomaceous earth, urea-based resins, styrene beads, fired clay, starch and the like. The preferred shape for these is preferably spherical, and their sizes (diameter in the case of a spherical shape) are not particularly limited.

The hot melt PSA of the present invention may be produced by blending the component (A), the component (B), the component (C) and the component (D), and preferably wax, a plasticizer and a stabilizer, and as required, further various additives, using a commonly known method for producing the hot melt PSA. The hot melt PSA may be produced by blending predetermined amounts of the above-described components, and heating and melting them. The order of adding the components, the heating method and the like are not particularly limited as long as the targeted hot melt PSA is obtained.

In the hot melt PSA of the present invention, the blending amount of the component (A) is not particularly limited, but is preferably 10 to 30 parts by mass, more preferably 15 to 30 parts by mass, and still more preferably 15 to 25 parts by mass, based on 100 parts by mass of the total mass of the component (A), the component (B), the component (C) and the component (D).

With the blending amount of the component (A) within the above range, the alkali-dispersible type hot melt PSA of the present invention has increased cohesive force, making it easier to apply the label to the container without displacing it. This results in an improved shear strength at the adhesive portions between body-wrapping labels (for example, between OPP films). Furthermore, the blending amount of the thermoplastic block copolymer (A) also contributes to stringiness reduction of the hot melt PSA.

In the hot melt PSA of the present invention, the blending amount of the component (B) is not particularly limited, but is preferably 1 to 20 parts by mass, more preferably 3 to 15 parts by mass, and still more desirably 4 to 10 parts by mass, based on 100 parts by mass of the total mass of the component (A), the component (B), the component (C) and the component (D). The blending amount of the component (B) within the above range makes the hot melt PSA of the present invention exhibit an excellent balance between label-holding strength and adhesive residue. Furthermore, even when a container with a label having the hot melt PSA of the present invention is transported for an extended period, the film overlapping portions of the body-wrapping label are hardly peeled off from the container due to vibrations and the like during transportation.

In the hot melt PSA of the present invention, the blending amount of the component (C) is not particularly limited, but is preferably 40 to 80 parts by mass, more preferably 50 to 75 parts by mass, and most desirably 60 to 71 parts by mass, based on 100 parts by mass of the total mass of the component (A), the component (B), the component (C) and the component (D). With the blending amount of the component (C) within the above range, the hot melt PSA of the present invention becomes stable as a PSA, resulting in an excellent balance of holding strength, reduction of adhesive residue, and reduction of stringiness. Furthermore, even when a container with the label having the hot melt PSA of the present invention is transported for an extended period, the film overlapping portions of the body-wrapping label are hardly peeled off from the container due to vibrations and the like during transportation.

In the hot melt PSA of the present invention, the blending amount of the component (D) is not particularly limited, but is preferably 5 to 18 parts by mass, more preferably 7 to 15 parts by mass, and more preferably 9 to 13 parts by mass, based on 100 parts by mass of the total mass of the component (A), the component (B), the component (C) and the component (D). With the blending amount of the component (D) within the above range, the hot melt PSA of the present invention has improved alkali dispersibility, is capable of reducing adhesive residue on the adherend while maintaining the holding strength, and also contributes to stringiness reduction. Furthermore, even when a container with the label having the hot melt PSA of the present invention is transported for an extended period, the film overlapping portions of the body-wrapping label are hardly peeled off from the container due to vibrations and the like during transportation.

In the hot melt PSA of the present invention, the total content of the component (A), the component (B), the component (C) and the component (D) based on the total mass of the hot melt PSA is not particularly limited, but is preferably 50 parts by mass or more, more preferably 60 to 85 parts by mass, and still more preferably 65 to 75 parts by mass.

In the hot melt PSA of the present invention, the blending amount of the wax is not particularly limited, and may be 0 parts by mass, but is preferably 1 to 10 parts by mass, more preferably 2 to 8 parts by mass, and still more preferably 2.5 to 6 parts by mass, based on 100 parts by of the total amount of the component (A), the component (B), the component (C) and the component (D).

In one aspect of the present invention, the hot melt PSA preferably comprises Fischer-Tropsch wax, and the blending amount of Fischer-Tropsch wax based on the total amount of the wax is not particularly limited, but is preferably 50% by mass or more, more preferably 65% by mass or more, and may be 100% by mass.

As one preferred aspect of the present invention, the hot melt PSA preferably has a viscosity (or melt viscosity) at 160° C. of 4000 mPa s or less, more preferably 3000 mPa s or less, and still more preferably 2000 mPa s or less. With the viscosity at 160° C. within the above range, the hot melt PSA becomes even more suitable for coating. The viscosity (or melt viscosity) at 160° C. herein means the value measured with a Brookfield viscometer using a No. 27 rotor.

The label of the present invention has a substrate and a PSA layer consisting of the above hot melt PSA. Specific examples of the substrate include papers such as a paper, a processed paper (paper that has been subjected to aluminum vapor deposition processing, aluminum lamination processing, varnishing, resin processing or the like) and a synthetic paper, an organic compound film, an inorganic compound film, a metal film and the like.

As the label substrate, a film made of an organic compound which is often used for alkali washing, such as polypropylene, polyethylene terephthalate (PET) or polylactic acid (PLA) is particularly preferable. As the polypropylene film, a biaxially oriented polypropylene (OPP) film is particularly preferable.

The PSA layer may be formed on the entire back surface of the label or a part of the back surface of the label. For example, in the body-wrapping label, the PSA layer may be formed on overlapping portions at both ends of the film where they are bonded to each other when it is wrapped around a body portion of the container.

The PSA layer may be formed by applying the hot melt PSA to the surface of the substrate. Examples of the coating method include an open wheel method, a closed gun method, a direct coating method and the like. The open wheel method and the direct coating method are preferred as a method in which the adhesive does not remain on the PET bottle when the label is peeled off.

The container of the present invention is one with the above label applied to its surface. Examples of such a container include a glass container such as a glass bottle used for a soft drink, a seasoning, a detergent, a shampoo, a cooking oil, a cosmetic, a pharmaceutical, and the like; a plastic container such as a PET (polyethylene terephthalate) bottle; and a metal can such as an aluminum can. Among the above-mentioned containers, a PET bottle is particularly preferable in the present invention. In one embodiment of the present invention, examples of the PET bottle having the label of the present invention applied thereto include one with a label applied to a part of the waist circumference of the PET bottle, and one with a “body-wrapping label” wrapped around the waist circumference of the bottle so as to circumferentially cover it. Since the hot melt PSA of the present invention is excellent in holding strength, displacement or lifting of the label may be suppressed even if the container such as a PET bottle expands due to the container being filled with a carbonated beverage or the like.

The hot melt PSA of the present invention is preferably used for adhesion of the body-wrapping label. As the substrate of the body-wrapping label, biaxially oriented polypropylene (OPP) film may be used. The label on which the hot melt PSA of the present invention is applied may be printed or may not be printed. When a printed label is used, the hot melt PSA of the present invention may be applied not only on the non-printed surface but also on the printed surface.

As one type of device for applying a label to a PET bottle using the hot melt PSA of the present invention, an open wheel type device may be exemplified. The hot melt PSA is melted at 120 to 190° C. and applied on the back surface of the label by the open wheel type device. This label is applied to the PET bottle to manufacture the container of the present invention.

The container to which the label is applied by the hot melt PSA of the present invention is suitable for reuse or the like of the container because the label is easily peeled off from the container when it is immersed in a hot aqueous alkaline solution. The method of peeling off the label with a hot aqueous alkaline solution is not particularly limited, but examples thereof include a method in which the container to which the label is applied is cut into small pieces and into pellets, the pellets are put into the hot aqueous alkaline solution (for example, an aqueous solution of sodium hydroxide having a concentration of 0.5 to 5.0% by mass at a temperature of 80° C. to 90° C.) and stirring is performed for about 1 minute to 20 minutes.

In the container to which the label is applied with the hot melt PSA of the present invention, it has sufficient adhesiveness without the label being peeled off from the container during normal use of the container, while on the other hand, when the label is peeled off after using the container and the like, it can also be peeled off by hand without adhesive residue and is thus excellent in re-peelability.

Furthermore, even when the container with the label is transported for an extended period, the film overlapping portions of the body-wrapping label won't be peeled off from the container due to vibrations and the like during transportation.

### EXAMPLES

For the purpose of describing the present invention in more detail and more specifically, the present invention will be described below using Examples. These Examples do not limit the present invention.

In Examples and Comparative Examples, the components to be blended in the hot melt PSA are shown below.
(A) Thermoplastic Block Copolymer
(A1) Styrene-based block copolymer having a styrene content of less than 40% by mass
(A1-1) Styrene-ethylene/butylene-styrene triblock copolymer (Kraton G-1652 (trade name) manufactured by Kraton Corporation, styrene content 30% by mass, diblock content 0% by mass, weight-average molecular weight 72,000)
(A1-2) Styrene-ethylene/butylene-styrene triblock copolymer (Kraton G-1650 (trade name) manufactured by Kraton Corporation, styrene content 30% by mass, diblock content 0% by mass, weight-average molecular weight 92,000)
(A1-3) Styrene-ethylene/butylene-styrene block copolymer (Kraton G-1726 (trade name) manufactured by Kraton Corporation, styrene content 31% by mass, diblock content 73% by mass, weight-average molecular weight 43,000)
(A1-4) Styrene-ethylene/butylene-styrene block copolymer (Kraton G-1657 (trade name) manufactured by Kraton Corporation, styrene content 15% by mass, diblock content 33% by mass, weight-average molecular weight 106,000)
(A2) Styrene-based block copolymer having a styrene content of 40% by mass or more
(A2-1) Styrene-ethylene/butylene-styrene triblock copolymer (Tuftec H1043 (trade name) manufactured by Asahi Kasei Chemicals Corp., styrene content 68% by mass, diblock content 0% by mass, weight-average molecular weight 53,000)
(A2-2) Styrene-butadiene/butylene-styrene triblock copolymer (Tuftec P2000 (trade name) manufactured by Asahi Kasei Chemicals Corp., styrene content 68% by mass, diblock content 0% by mass, weight-average molecular weight 54,000)
(A2-3) Styrene-butadiene-styrene block copolymer (Asaprene T-439 (trade name) manufactured by Asahi Kasei Chemicals Corp., styrene content 46% by mass, diblock content 69% by mass, weight average molecular weight 63,000)
(A2-4) Styrene-isoprene-styrene triblock copolymer (Kraton D-1162P (trade name) manufactured by Kraton Corporation, styrene content 41% by mass, diblock content 0% by mass, weight-average molecular weight 82,000)
(B) Metallocene Olefin Polymer
(B1) Metallocene ethylene/propylene copolymer (Vistamax 8780 (trade name) manufactured by Exxon Mobil Corporation, weight-average molecular weight: 30,000, ethylene content: 12% by mass)
(B2) Metallocene ethylene/propylene copolymer (Vistamax 8880 (trade name) manufactured by Exxon Mobil Corporation, weight-average molecular weight: 25,000, ethylene content: 6.0% by mass, melting point: 97° C., Melt viscosity at 190° C.: 1200 mPa s)
(B3) Metallocene ethylene/propylene copolymer (Affinity GP 1570 (trade name) manufactured by Dow Chemical Company, weight-average molecular weight: 35,000, melt viscosity at 177° C.: 12500 mPa s)
(B4) Metallocene ethylene/octene copolymer (Affinity GA 1900 (trade name) manufactured by Dow Chemical Company, weight-average molecular weight: 30,000, 1-octene content: 35 to 37% by mass, melt flow rate: 1000 g/10 min)
(B5) Metallocene ethylene/octene copolymer (Engage 8137 (trade name) manufactured by Dow Chemical Company, weight-average molecular weight: 200,000, 1-octene content: 13% by weight, melt flow rate: 13 g/10 min)
(B6) Metallocene ethylene/octene copolymer (Infuse 9808 (trade name) manufactured by Dow Chemical Company, weight-average molecular weight: 200,000, melt flow rate: 15 g/10 min) (B7) Metallocene ethylene/hexene copolymer (Kernel KJ 604T (trade name) manufactured by Japan Polyethylene Corporation, weight-average molecular weight: 130,000, melt flow rate: 30 g/10 min, melting point 58° C.)
(B8) Metallocene propylene homopolymer (L-MODU S400 (trade name) manufactured by Idemitsu Kosan Co., Ltd., weight-average molecular weight 450,000, melting point 75° C., polydispersity 2.0)
(B9) Metallocene propylene homopolymer (L-MODU S600 (trade name) manufactured by Idemitsu Kosan Co., Ltd., weight-average molecular weight 70,000, melting point 80° C., polydispersity 2.0)
(B10) Metallocene ethylene/1-butene copolymer (TAFMER DF 7350 (trade name) manufactured by Mitsui Chemicals, Inc. weight-average molecular weight: 120,000, melt flow rate: 35 g/10 min, melting point 55° C.)
(B′11) Ziegler-Natta propylene homopolymer (Eastoflex P1010PL (trade name) manufactured by Eastman Chemical Company, weight-average molecular weight: 260,000, melt viscosity at 190° C.: 1000 mPa s, softening point 155° C., density 0.87 g/cm³)
(B′12) Ziegler-Natta ethylene/propylene copolymer (Eastoflex E1016 (trade name) manufactured by Eastman Chemical Company, weight-average molecular weight: 380,000) (B′13) Ziegler-Natta ethylene/propylene/butene copolymer (VESTOPLAST 708 (trade name) manufactured by Evonik Corporation, weight-average molecular weight: 78,000, melt flow rate: 450 g/10 min, melting point: 124° C., melt viscosity at 190° C.: 2700 mPa s)
(C) Tackifying Resin
(C1) Hydrogenated alicyclic/aromatic copolymer hydrocarbon resin (T-REZ HC103 (trade name) manufactured by ENEOS Corporation, softening point 103° C.)
(C2) Hydrogenated alicyclic hydrocarbon resin (T-REZ HA103 (trade name) manufactured by ENEOS Corporation, softening point 103° C.)
(C3) Hydrogenated alicyclic hydrocarbon resin (T-REZ HA 125 (trade name) manufactured by ENEOS, softening point 125° C.)
(C4) Hydrogenated rosin ester (KOMOTAC KHR75 (trade name) manufactured by GUANGDONG KOMO CO., LTD., acid value 170 mgKOH/g, softening point 80° C.)
(C5) Hydrogenated rosin ester (Foral AX-E (trade name) manufactured by Eastman Chemical Company, acid value 160 mgKOH/g, softening point 80° C.)
(C6) Hydrogenated rosin ester (Foral 85E (trade name) manufactured by Eastman Chemical Company, acid value 9 mgKOH/g, softening point 85° C.)
(C7) Rosin ester (KOMOTAC K107 (trade name) manufactured by GUANGDONG KOMO CO., LTD., acid value 155 mgKOH/g, softening point 80° C.)
(C8) Rosin ester (KOMOTAC KB90H (trade name) manufactured by GUANGDONG KOMO CO., LTD., acid value 15 mgKOH/g, softening point 90° C.)
(C9) alpha-methylstyrene-based resin (Kristalex 3070 (trade name) manufactured by Eastman Chemical Company, softening point 70° C.)
(C10) alpha-methylstyrene-based resin (Kristalex 3085 (trade name) manufactured by Eastman Chemical Company, softening point 85° C.)
(C11) α-methylstyrene-based resin (Kristalex 3100 (trade name) manufactured by Eastman Chemical Company, softening point 100° C.)
(D) At Least one selected from the Group Consisting of Fatty Acids and Derivatives Thereof
(D1) Fatty acid derivative having a melting point of 40° C. or more
(D1-1) Hardened castor oil (hardened castor oil A (trade name) manufactured by ITOH OIL CHEMICALS CO., LTD., melting point 85.5° C.)
(D1-2) Monohydroxystearic acid-hardened castor oil (Technol MH (trade name) manufactured by YOKOZEKI OIL & FAT INDUSTRIES CO., LTD., melting point 58.0° C.)
(D1-3) Hydrogenated castor oil laurate (Technol ML98 (trade name) manufactured by YOKOZEKI OIL & FAT INDUSTRIES CO., LTD., melting point 51.0° C.)
(D1-4) Castor hardened fatty acid (12-hydroxystearic acid (trade name) manufactured by NOF Corporation, melting point 69.0° C.)
(D1-5) Beef tallow hardened oil (TALLOW HARDENED OIL 510 HO (trade name) manufactured by NOF CORPORATION, melting point 51.0° C.)
(D1-6) Extremely hardened soybean oil (hydrogenated soybean oil (trade name) manufactured by Yamakei Sangyo Co., Ltd., melting point 68.2° C.)
(D1-7) Rice wax extremely hardened rapeseed oil (Rice wax SS-1 (trade name) manufactured by Boso oil and fat Co., Ltd., melting point 79.0° C.)
(D2) Fatty acid derivative having a melting point of less than 40° C.
(D2-1) Castor oil (Industrial No. 1 Castor oil (trade name) manufactured by HOKOKU CORPORATION, no melting point (freezing point−22° C.)
(D2-2) Rice oil (rice salad oil (trade name) manufactured by Boso oil and fat Co., Ltd., no melting point (freezing point-10 to −5° C.))
(D2-3) Sunflower oil (high oleic sunflower oil (trade name) manufactured by Yamakei Sangyo Co., Ltd., no melting point (freezing point-18 to ˜16° C.))
(E) Wax
(E1) Fischer-Tropsch wax (Sasol C80 (trade name) manufactured by Sasol Limited, weight-average molecular weight: 620, melting point 80° C., penetration degree 7)
(E2) Fischer-Tropsch wax (Sasol H1 (trade name) manufactured by Sasol Limited, weight-average molecular weight: 880, melting point 108° C., penetration degree 2)
(E3) Ethylene-vinyl acetate copolymer wax (AC400 (trade name) manufactured by Honeywell Corporation, weight-average molecular weight: 400, melting point 92° C.)
(E4) Polyethylene wax (Highwax 320P (trade name) manufactured by Mitsui Chemicals, Inc., weight-average molecular weight: 3000, melting point 109° C., penetration degree 7)
(E5) Polypropylene wax Hi-Wax NP105 (trade name) manufactured by Mitsui Chemicals, Inc., weight-average molecular weight: 10,000, melting point 140/148° C., penetration degree 1)
(E6) Paraffin wax (Paraffin wax 150F (trade name) manufactured by Nippon Seiro Co., Ltd., weight-average molecular weight: 400, melting point 66° C., penetration degree 12)
(E7) Maleic anhydride-modified polypropylene wax (Licocene PPMA6252 (trade name) manufactured by Clariant Corporation, weight-average molecular weight: 4000, melting point 140° C.)
(F) Plasticizer (Oil)
(F1) Paraffin oil (Daphne oil KP-68 (trade name) manufactured by Idemitsu Kosan Co., Ltd.)
(F2) Paraffin oil (Diana Process oil PW (trade name) manufactured by Idemitsu Kosan Co., Ltd.)
(F3) Polybutene (Nisseki Polybutene HV-300 (trade name) manufactured by Nippon Oil Co., Ltd.)
(F4) Naphthene oil (DN4010 (trade name) manufactured by PetroChina Company Limited)
(G) Stabilizer (Antioxidant)
(G1) Hindered phenol-based antioxidant (ADEKA STAB AO-60 (trade name) manufactured by ADEKA Corporation)
(G2) Phosphorous-based antioxidant (Irgafos 168 (trade name) manufactured by BASF Japan Limited)

The components (A) to (G) were blended in the proportions shown in Tables 1 and 2, and melted and mixed at about 145° C. for about 3 hours using a universal stirrer to prepare hot melt PSAs of Examples 1 to 16 and Comparative Examples 1 to 4. The numerical values regarding the compositions (blends) of the hot melt PSAs shown in Table 1 are all in parts by mass.

Respective hot melt PSAs of Examples and Comparative Examples were evaluated for alkali dispersibility, holding strength, adhesive residue, stringing properties, and shear strength at adhesive portions between the body-wrapping labels. Each measurement method and evaluation method will be described below.

### <Alkali Dispersibility>

The hot melt PSA of each Examples and Comparative Examples were coated onto an OPP film to have a thickness of 20 to 25 μm to prepare a label (25 mm×50 mm) of the OPP film with the hot melt PSA. This label was bonded by pressing it against an empty PET bottle at 100° C. for 5 seconds to prepare a test sample. After measuring the mass of this test sample (the mass of the test sample before washing), it was placed in a 1.5% by mass aqueous sodium hydroxide solution at 85° C. and stirred (washed) for 15 minutes. After 15 minutes, the test sample was taken out and air-dried sufficiently. The mass of the test sample after the air-drying (the mass of the test sample after washing) was measured, and the alkali dispersion ratio was calculated from the mass before and after washing. The alkali dispersion ratio was calculated from the following formula, and the alkali dispersibility was evaluated from the calculated value.

Alkali dispersion ratio (%)={(mass of the test sample before washing−mass of the test sample after washing)/(mass of the hot melt PSA used)}×100

The evaluation results are shown in Table 3. The evaluation criteria are as follows.
A: Alkali dispersion ratio was more than 90%.
B: Alkali dispersion ratio was 60% or more and 90% or less.
C: Alkali dispersion ratio was less than 60%, or measurement was impossible because the film did not adhere and a test sample could not be prepared.
   <Holding Strength (Lifting and Displacement of Label when PET Bottle Expands)>

A hot melt PSA was applied on an OPP film to have a thickness of 20 to 25 μm to prepare an OPP label (25 mm×50 mm) with the hot melt PSA. The label was bonded by pressing it against an empty PET bottle at 100° C. for 5 seconds to prepare a test sample.

Next, the PET bottle was filled with a carbonated beverage, and the test sample containing the carbonated beverage was stored in an atmosphere of 40° C. for one week. Another test sample containing a carbonated beverage was stored in an atmosphere of −10° C. for 3 days, and the label lifting and label displacement width of each test sample was checked.

The evaluation results are shown in Table 3. The evaluation criteria are as follows.
A: No label lifting and the label displacement width was less than 2 mm.
B: No label lifting, and the label displacement width was 2 mm or more and less than 4 mm.
C: No label lifting, and the label displacement width was 4 mm or more and less than 7 mm.
D: Label lifting was observed, or the label displacement width was 7 mm or more.

### <Adhesive Residue>

The hot melt PSA was applied on an OPP film to have a thickness of 20 to 25 μm to prepare an OPP label (25 mm×50 mm) with the hot melt PSA. The label was bonded by pressing it against an empty PET bottle at 100° C. for 5 seconds to prepare a test sample. After storing the test sample at 0° C. for 7 days, the label was peeled off from the PET bottle by hand, and the adhesion state of the hot melt PSA to the PET bottle was visually checked. Another test sample containing a carbonated beverage was also stored in an atmosphere of 40° C. for 7 days, the label was peeled off from the PET bottle by hand, and the adhesion state of the hot melt PSA to the PET bottle was visually checked.

The evaluation results are shown in Table 3. The evaluation criteria are as follows.
A: Interfacially peeled off, and no attachment of the hot melt PSA.
B: Slight adhesion of the hot melt PSA.
C: Cohesive failure, and most of the hot melt PSA remains on the PET bottle.

### <Stringing Properties>

The hot melt PSA was intermittently applied vertically to an adherend that was 20 cm away from the tip of a hot melt gun. The state of a falling object between the hot melt gun and the adherend was visually checked to evaluate stringing properties. The measurement conditions are as follows.

Temperature settings: The tank internal temperature, hose internal temperature, and nozzle internal temperature are all 160° C.
Nozzle diameter: 14/1000 inch
Nozzle: Single nozzle
Application pressure: 0.3 MPa
Application shot number: 90 shots/3 minutes

The evaluation results are shown in Table 3. The evaluation criteria are as follows.
A: Falling objects fell away from the nozzle (no stringiness).
B: Falling objects adhere around the nozzle (with stringiness).

### <Shear Strength at Adhesive Portions Between Body-Wrapping Labels (OPP/OPP)>

After applying the hot melt adhesive on an OPP film to have a thickness of 20 to 25 μm, the OPP film was cut into 25 mm×50 mm. After further overlapping an OPP film so that the adhesive surface was 25 mm×25 mm, the films were bonded by pressing them at 100° C. for 3 seconds to prepare a sample.

After being stored for one day at 23° C. in a 55% atmosphere, the films were subjected to a tensile test in the shear direction to measure the shear strength.

The evaluation results are shown in Table 3. The evaluation criteria are as follows.
A: Shear strength of greater than 10 kg/cm2
B: Shear strength of 5 kg/cm2 or more and 10 kg/cm2 or less
C: Shear strength of 3 kg/cm2 or more and 5 kg/cm2 or less
D: Shear strength of less than 3 kg/cm2

TABLE 1

| | Example | | | | | | | | | | |
|---|---|---|---|---|---|---|---|---|---|---|---|
| | 1 | 2 | 3 | 4 | 5 | 6 | 7 | 8 | 9 | 10 | 11 |
| A1-1 | 13.7 | 13.5 | 13.5 | 13.9 | 14.5 | 14.5 | 10.8 | 18.3 | 14.3 | 18.6 | 15.7 |
| A1-2 | 2.7 | 4.1 | 2.7 | 2.8 | 2.9 | 2.9 | | | 2.9 | | |
| A1-3 | | | | 1.4 | | | | | | | |
| A1-4 | | 1.4 | | | | | 5.4 | | | | 1.3 |
| A2-1 | | | | | | | | | 1.4 | | |
| A2-2 | | | | | | | | | | 1.5 | |
| A2-3 | | | | | | | | 1.4 | | | |
| A2-4 | | | | | | | | | | | 1.3 |
| B1 | 6.9 | | | | | | 6.8 | | | 6.7 | |
| B2 | | 6.7 | | | | | | 9.9 | | | 5.2 |
| B3 | | | 4.1 | | | | | | | | |
| B4 | | | | 4.2 | | | | | | | 2.7 |
| B5 | | | | | 4.4 | | | | | | |
| B6 | | | | | | 4.4 | | | | | |
| B7 | | | | | | | | | 4.3 | | |
| B8 | | | | | | | | | | | |
| B9 | | | | | | | | | | | |
| B10 | | | | | | | | | | | |
| B′11 | | | | | | | | | | | |
| B′12 | | | | | | | | | | | |
| B′13 | | | | | | | | | | | |
| C1 | 17.8 | 17.5 | 18.9 | 18.0 | 16.0 | 16.0 | 13.5 | 14.0 | 14.3 | 13.3 | 13.1 |
| C2 | | | | | | | | | | 16.0 | |
| C3 | 16.4 | 14.8 | 17.6 | 16.6 | 17.4 | 17.3 | 13.5 | 14.1 | 20.0 | | 19.7 |
| C4 | 27.4 | 27.0 | 23.0 | 20.8 | 29.0 | 29.0 | | 21.2 | 25.7 | 20.0 | 26.3 |
| C5 | | | 4.0 | | | | 33.8 | | | | |
| C6 | | | | 7.0 | | | | 5.6 | 2.9 | 6.7 | |
| C7 | | | | | | | | 1.4 | | | |
| C8 | | 1.4 | | | | | | | | | |
| C9 | | | | | 1.5 | 2.9 | | | | | |
| C10 | 5.5 | 4.1 | 5.4 | 5.6 | 4.4 | | 4.1 | | 4.3 | 5.3 | |
| C11 | | | | | | 2.9 | | 4.2 | | | 3.9 |
| D1-1 | 9.6 | 9.5 | 10.8 | 8.3 | 7.2 | 7.3 | 9.5 | | 8.6 | 10.6 | 9.3 |
| D1-2 | | | | | 2.9 | | | 5.6 | | | |
| D1-3 | | | | | | 2.9 | | | | | |
| D1-4 | | | | 1.4 | | | | | | | |
| D1-5 | | | | | | | 2.8 | | | | |
| D1-6 | | | | | | | | 4.2 | | | |
| D1-7 | | | | | | | | | 1.3 | | |
| D2-1 | | | | | | | | | | 1.3 | |
| D2-2 | | | | | | | | | | | 1.4 |
| D2-3 | | | | | | | | | | | |
| Total of | 100.0 | 100.0 | 100.0 | 100.0 | 100.0 | 100.0 | 100.0 | 100.0 | 100.0 | 100.0 | 100.0 |
| A to D | | | | | | | | | | | |
| E1 | 2.7 | 2.7 | 2.7 | 2.8 | 2.9 | 2.9 | | 2.8 | 2.9 | 2.7 | 2.6 |
| E2 | | | | | 1.5 | 1.5 | 2.7 | | | | |
| E3 | | | | | | | | 1.4 | | | |
| E4 | | | | | | | | | | 1.3 | |
| E5 | | | | | | | | | | | |
| E6 | | | | | | | | | 2.9 | | |
| E7 | | | | | | | | | | | 1.3 |
| F1 | 20.6 | 18.9 | 18.9 | 20.9 | 21.8 | 14.5 | 18.9 | 21.2 | 21.5 | 14.6 | 10.5 |
| F2 | | | | | | 7.3 | | | | | |
| F3 | | | | | | | | | | | 2.6 |
| F4 | 13.7 | 13.5 | 13.5 | 15.3 | 18.9 | 18.9 | 13.5 | 15.5 | 15.7 | 14.6 | 14.4 |
| G1 | 0.4 | 0.4 | 0.4 | 0.4 | 0.4 | 0.3 | 0.4 | 0.4 | 0.4 | 0.4 | 0.4 |
| G2 | 0.3 | 0.3 | 0.3 | 0.3 | 0.3 | 0.2 | 0.3 | 0.3 | 0.3 | 0.3 | 0.3 |
| Total of | 137.68 | 135.8 | 135.8 | 139.7 | 145.7 | 145.4 | 135.8 | 141.6 | 143.6 | 133.9 | 132.1 |
| A to G | | | | | | | | | | | |

TABLE 2

| | Example | | | | | Comparative Example | | | |
|---|---|---|---|---|---|---|---|---|---|
| | 12 | 13 | 14 | 15 | 16 | 1 | 2 | 3 | 4 |
| A1-1 | 13.3 | 13.5 | 17.6 | 16.0 | 13.7 | 18.3 | 20.4 | 38.4 | |
| A1-2 | 2.7 | 1.4 | | | 2.7 | 2.8 | 4.0 | 3.8 | |
| A1-3 | | | | 1.3 | | | | | |
| A1-4 | | | | | | | | | |
| A2-1 | | | | | | | | | |
| A2-2 | | | | | | | | | |
| A2-3 | | | | | | | | | |
| A2-4 | | | | | | | | | |
| B1 | | | 4.1 | | 4.1 | | 5.5 | 9.6 | 13.3 |
| B2 | | | | 4.0 | | | | | |
| B3 | | | | | | | | | |
| B4 | | | | | | | | | |
| B5 | | | | | | | | | |
| B6 | | | | | | | | | |
| B7 | | | | | | | | | |
| B8 | 6.8 | | | | | | | | 13.3 |
| B9 | | 5.4 | | | | | | | |
| B10 | | | 1.4 | | | | | | |
| B′11 | | | 1.4 | | | | | | |
| B′12 | | | | 1.3 | | | | | |
| B′13 | | | | | 1.4 | | | | |
| C1 | 16.0 | 17.6 | 17.6 | 17.3 | 17.8 | 18.3 | 19.4 | | 17.3 |
| C2 | 13.4 | | | | | | | | |
| C3 | 6.7 | 20.3 | 17.6 | 17.3 | 17.8 | 16.9 | 18.9 | | 20.0 |
| C4 | 20.0 | 27.0 | 20.3 | 26.7 | 27.4 | 21.2 | 23.4 | | 26.7 |
| C5 | 6.7 | | | | | 7.1 | 8.4 | | |
| C6 | | | 6.8 | | | | | | |
| C7 | | | | | | | | | |
| C8 | | | | | | | | | |
| C9 | | | | | | | | | |
| C10 | 4.0 | 4.1 | 4.1 | 5.4 | 5.5 | 5.6 | | | |
| C11 | | 1.4 | | | | | | | |
| D1-1 | 5.3 | 9.5 | 6.8 | 10.7 | 9.6 | 7.1 | | 38.5 | 9.4 |
| D1-2 | 4.0 | | 2.7 | | | 2.7 | | 9.7 | |
| D1-3 | | | | | | | | | |
| D1-4 | | | | | | | | | |
| D1-5 | | | | | | | | | |
| D1-6 | | | | | | | | | |
| D1-7 | | | | | | | | | |
| D2-1 | | | | | | | | | |
| D2-2 | | | | | | | | | |
| D2-3 | 1.3 | | | | | | | | |
| Total of | 100.0 | 100.0 | 100.0 | 100.0 | 100.0 | 100.0 | 100.0 | 100.0 | 100.0 |
| A to D | | | | | | | | | |
| E1 | 2.7 | 4.1 | 2.7 | 2.66 | 2.74 | 7.1 | | 28.8 | 6.7 |
| E2 | | | | | | | | | |
| E3 | | | | | | | | | |
| E4 | | | | | | | | | |
| E5 | 1.3 | | | | | | | | |
| E6 | | | | | | | | | |
| E7 | | | | | | | 17.9 | | |
| F1 | 18.6 | 18.9 | 17.6 | 17.3 | 20.6 | 19.7 | 19.4 | 38.4 | 13.3 |
| F2 | | | | | | | | | |
| F3 | | | | | | | | | |
| F4 | 13.3 | 12.2 | 14.9 | 13.3 | 13.7 | 14.1 | 14.9 | 24.96 | 13.3 |
| G1 | 0.4 | 0.4 | 0.4 | 0.4 | 0.4 | 0.4 | 0.4 | 0.6 | 0.4 |
| G2 | 0.3 | 0.3 | 0.3 | 0.3 | 0.3 | 0.3 | 0.3 | 0.4 | 0.3 |
| Total of | 136.6 | 135.7 | 135.7 | 133.9 | 137.7 | 141.6 | 152.9 | 193.2 | 133.9 |
| A to G | | | | | | | | | |

TABLE 3

| | | Example | | | | | | | | | | | | | | | | Comparative Example | | | |
|---|---|---|---|---|---|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 | 15 | 16 | 1 | 2 | 3 | 4 |
| Alkali dispersibility | Stirred in 1.5% | A | A | A | A | A | A | A | A | A | A | A | A | A | A | A | A | A | D | B | A |
| | aqueous NaOH | | | | | | | | | | | | | | | | | | | | |
| | solution at 85° C. | | | | | | | | | | | | | | | | | | | | |
| | for 15 min | | | | | | | | | | | | | | | | | | | | |
| Lifting and | after 40° C. × | A | A | A | B | A | A | A | A | A | A | A | A | A | A | A | A | A | A | D | D |
| displacement | 7 days | | | | | | | | | | | | | | | | | | | | |
| of label when PET | −10° C. × 3 | A | A | A | A | A | A | A | B | B | A | B | C | B | A | A | A | D | D | D | D |
| bottle expands | days | | | | | | | | | | | | | | | | | | | | |
| Adhesive residue | after 0° C. × 7 | A | A | A | A | A | A | A | A | A | A | B | B | B | A | A | A | D | D | D | D |
| remaining on PET | days | | | | | | | | | | | | | | | | | | | | |
| bottle | after 40° C. × 7 | A | A | A | A | A | A | A | A | A | A | A | A | A | A | A | A | B | A | D | D |
| | days | | | | | | | | | | | | | | | | | | | | |
| Shear strength at | 23° C. | A | A | A | B | B | B | A | A | B | A | B | A | A | A | A | A | D | D | D | D |
| adhesive portions | | | | | | | | | | | | | | | | | | | | | |
| between body- | | | | | | | | | | | | | | | | | | | | | |
| wrapping | | | | | | | | | | | | | | | | | | | | | |
| labels (OPP/OPP) | | | | | | | | | | | | | | | | | | | | | |
| Stringing | | B | B | B | B | B | B | B | B | B | B | B | B | B | B | B | B | B | D | D | D |
| properties | | | | | | | | | | | | | | | | | | | | | |

As shown in Tables 1 and 2, the alkali-dispersible type hot melt PSAs of Examples 1 to 16 have excellent alkali dispersibility and holding strength, are capable of reducing adhesive residue and stringiness, and also improve the shear strength at the adhesive portions between the body-wrapping labels, and all of performances were good.

On the other hand, the shear strength at the adhesive portions between the body wrapping labels was x in all of the hot melt PSAs of Comparative Examples 1 to 4, and x was also observed in any of the other performances.

From these results, it was confirmed that, by including includes the components (A), (B), (C), and (D), the hot melt PSA has high alkali dispersibility, excellent label-holding strength, leaves less adhesive residue, is capable of reducing stringiness, and exhibits excellent shear strength at the adhesive portions between the body-wrapping labels.

### INDUSTRIAL APPLICABILITY

The present invention can provide an alkali-dispersible type hot melt PSA, a label coated with the hot melt PSA, and a container to which the label is applied.

1: An alkali dispersible-type hot melt pressure-sensitive adhesive (PSA, comprising:
(A) a thermoplastic block copolymer that is a copolymer of vinyl aromatic hydrocarbons and conjugated diene compounds,
(B) a metallocene olefin polymer,
(C) a tackifying resin, and
(D) at least one selected from the group consisting of fatty acids and derivatives thereof.

2: The alkali dispersible-type hot melt PSA according to claim 1, comprising 1 to 20 parts by mass of the metallocene olefin polymer (B), based on 100 parts by weight of the total weight of components (A) to (D).

3: The alkali dispersible-type hot melt PSA according to claim 1, wherein the metallocene olefin polymer (B) has a weight-average molecular weight of 12,000 or more.

4: A label having a PSA layer consisting of the alkali dispersible-type hot melt PSA according to claim 1.

5: A container to which the label according to claim 4 is applied.
